(19) United States
(12) Patent Application Publication
(10) Pub. No.: US 2015/0362733 A1
(43) Pub. Date: Dec. 17, 2015

(54) WEARABLE HEAD-MOUNTED DISPLAY AND CAMERA SYSTEM WITH MULTIPLE MODES

(71) Applicant: Zambala LLLP, Henderson, NV (US)

(72) Inventor: Nova T. Spivack, Sherman Oaks, CA (US)

(21) Appl. No.: 14/738,182

(22) Filed: Jun. 12, 2015

Related U.S. Application Data
(60) Provisional application No. 62/011,673, filed on Jun. 13, 2014.

(51) Int. Cl. G02B 27/01; G06T 19/00

(52) U.S. Cl. CPC G02B 27/0172; G06T 19/006; G02B 2027/0138; G02B 2027/014; G02B 2027/0178; G02B 2027/0134; G02B 2027/0123

(57) ABSTRACT

Embodiments of the present disclosure include systems and methods for a wearable head-mounted display and camera system with multiple modes of user interaction including at in some embodiments a natural reality mode, an augmented reality mode, and a virtual reality mode.

### CROSS-REFERENCE TO RELATED APPLICATION(S)

This application claims the benefit of U.S. Provisional Application No. 62/011,673, filed on Jun. 13, 2014 entitled “A WEARABLE HEAD MOUNTED DISPLAY AND CAMERA SYSTEM WITH MULTIPLE MODES,” which is hereby incorporated by reference in its entirety. This application is therefore entitled to a priority date of Jun. 13, 2014.

This application is related to U.S. Pat. No. 8,745,494 (application Ser. No. 12/473,143), entitled “SYSTEM AND METHOD FOR CONTROL OF SIMULATED OBJECT THAT IS ASSOCIATED WITH A PHYSICAL LOCATION IN THE REAL WORLD ENVIRONMENT,” filed on May 27, 2009, issued on Jun. 3, 2014, which is hereby incorporated by reference in its entirety.

### TECHNICAL FIELD

This technology relates to augmented reality and virtual reality and in particular to a wearable head-mounted device for accessing multiple modes of user interaction.

### BACKGROUND

Currently available headset devices can offer either virtual reality (VR) or augmented reality (AR), but not both. Typical VR devices are implemented as head mounted displays that render an immersive environment for the user. Conversely, AR devices are implemented as head mounted displays that are either transparent heads-up-displays (HUDs) or use some form of projection, or render a real-world scene on a video output screen and project other information onto that video. The effect of AR devices is that information is displayed on top of what is seen through the eyes as one looks around and interacts with things in the world. Disclosed herein is a device capable of supporting both VR and AR modes of operation.

### BRIEF DESCRIPTION OF THE DRAWINGS

The present embodiments are illustrated by way of example and are not intended to be limited by the figures of the accompanying drawings. In the drawings:

FIG. 1A depicts a profile view of an example head-mounted device, according to some embodiments;

FIG. 1B depicts a front view of an example head-mounted device, according to some embodiments;

FIG. 2 depicts a display configuration for an example head-mounted device, according to some embodiments;

FIG. 3A depicts a functional block diagram of an example system suitable for use with a head-mounted device, according to some embodiments;

FIG. 3B depicts a hardware block diagram of system suitable for use with a head-mounted device, according to some embodiments;

FIGS. 4A-4C depict views that may be presented to a user while wearing a head-mounted device in each of three different modes, according to some embodiments;

FIG. 5 depicts a block diagram of an example system including client devices able to communicate with a host server, according to some embodiments;

FIG. 6 depicts a block diagram of the components of an example host server that generates and controls simulated objects for access via a head-mounted device, according to some embodiments;

FIG. 7A depicts a functional block diagram of an example host server that generates and controls access to simulated objects, according to some embodiments;

FIG. 7B depicts a hardware block diagram of an example host server that generates and controls access to simulated objects, according to some embodiments; and

FIG. 8 depicts a diagrammatic representation of a machine in the example form of a computer system within which a set of instructions, for causing the machine to perform any one or more of the methodologies discussed in this specification, can be executed.

### DETAILED DESCRIPTION

### Wearable Head-Mounted Display and Camera System with Multiple Modes

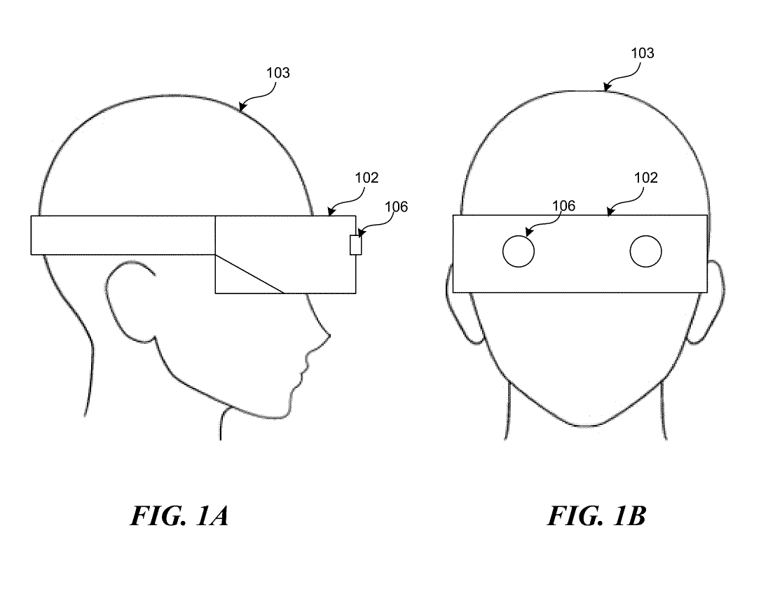

FIGS. 1A and 1B depict a profile and front view (respectively) of a user 103 wearing a head-mounted display device 102.

According to some embodiments of the present disclosure, a head mounted display device 102 is capable of a plurality of user interaction modes that includes a natural reality (NR) mode, an augmented reality (AR) mode, and a virtual reality (VR) mode. In some embodiments, the device may have only two modes (e.g. only natural and augmented, or only augmented and virtual)

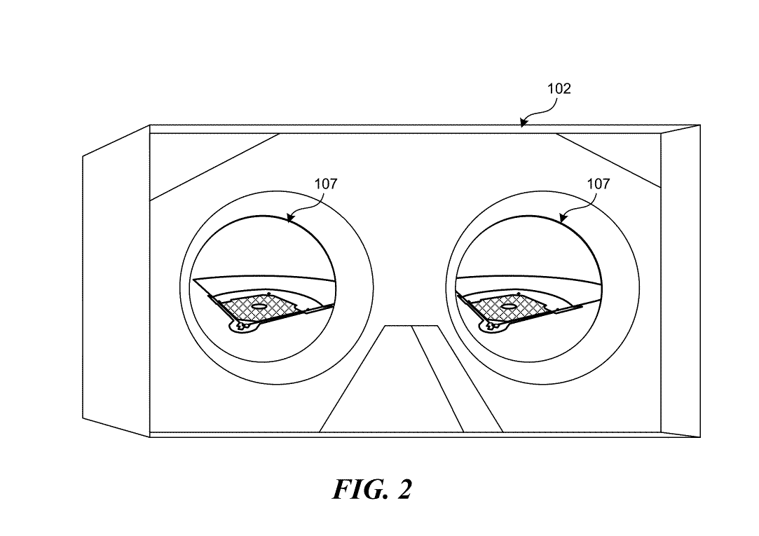

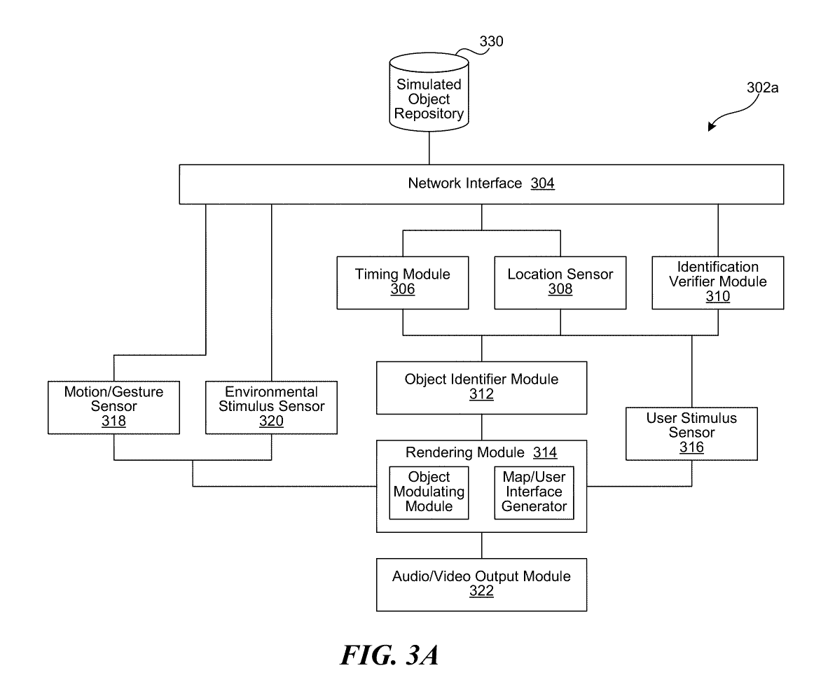

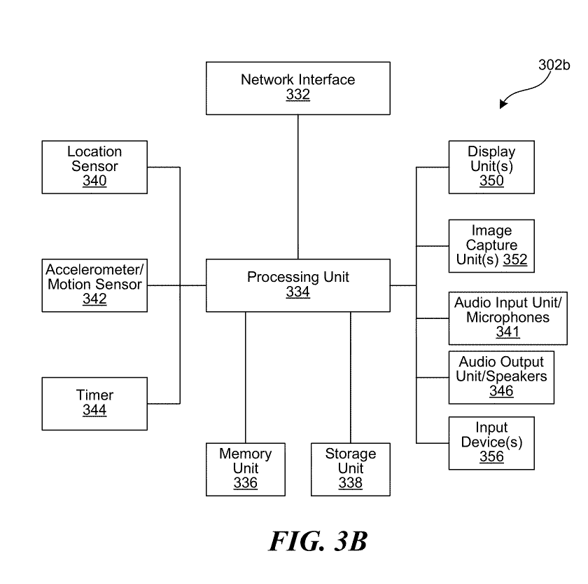

To accomplish multi-mode functionality, a display device (not shown) is coupled to one or more image capture devices 106 (e.g. front facing video cameras as shown in FIGS. 1A-1B). Image capture devices 106 may be the same or similar to image capture units 352 described in more detail with reference to FIG. 3B. Video captured by the image capture devices is presented to the user via the display devices integrated into the headset 102. The display devices are described in more detail with reference to FIG. 2.

In some embodiments, image capture devices 106 are not physically attached to head-mounted display device 102. In other words image capture, may be provided by devices not attached to the frame of head-mounted device 102. For example, image capture may be provided through external software that renders an actual reality, augmented reality or virtual reality environment via a remote computer system (e.g. from a remote server farm or computing loud application, or from a TV station, game host, or other content provider), or from one or more camera(s) on an airplane, vehicle, drone or a robot, or from camera(s) attached to the frame/headset worn by one or more other users in other locations, or cameras(s) attached to a location (e.g., a single or stereoscopic or 3D camera array that is placed above the 50 yard line of a Football stadium, or attached to near a major tourist location, etc.). Other inputs could may be from cameras or sensors in remote locations (underwater on the outside of a submarine, on lunar or Martian rover, or even from cameras mounted on the head or body of an autonomous vehicle or medical probe, or other type of remote sensor).

In some embodiments a user may switch between different image capture devices (e.g. via an input device). For example, using such a system the display of the image capture device could be configured to switch between the perspectives of a plurality of other users using other head-mounted devices 102.

In some embodiments, image capture may be shared with others (e.g. via a network interface and network connection) who have permission to view, according to permissions granted by each individual or by a central software application that controls access by users to image capture by other users according to a set of permissions.

By using mechanisms (e.g. software and/or hardware based) to select what is accessible to the user via the display a user can select one of a plurality of interaction modes (e.g. by selecting via an input device such as a button or a touch screen) and seamlessly switch between the different modes without having to change the head-mounted device. For example, the above described modes include a reality mode which includes only a live video feed from the image capture units 106. The video feed may be unaltered or may be subject to some processing in real time or near real time. For example, digital video may be adjusted for contrast, brightness, etc. to improve visibility to the user. An augmented reality mode takes this a step further and introduces additional processing and/or simulated objects that convey additional information to the user that may be pertinent to the observed physical environment captured via the image capture units, thereby “augmenting” reality for the user. Similarly an augmented reality mode may process the captured images to enhance vision in low light or low visibility levels through the use of infrared or ultraviolet imaging, edge detection, enhanced zoom, etc. In other words, present the captured images in a way that goes beyond the capabilities of the human eye. Finally, a virtual reality mode incorporates no (or very little) information from the image capture devices and instead presents for the user a fully simulated environment (e.g. computer generated) with other associated visual or audio information (e.g. simulated objects) populating the simulated environment (e.g., a 3D virtual reality game, a computer generated dataset, a desktop-like graphical user interface, etc.).

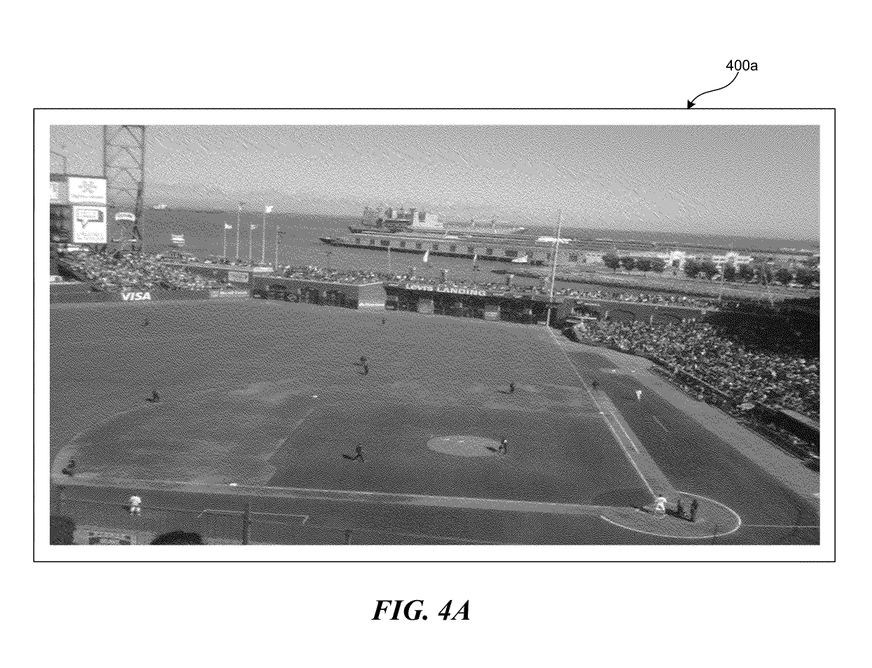

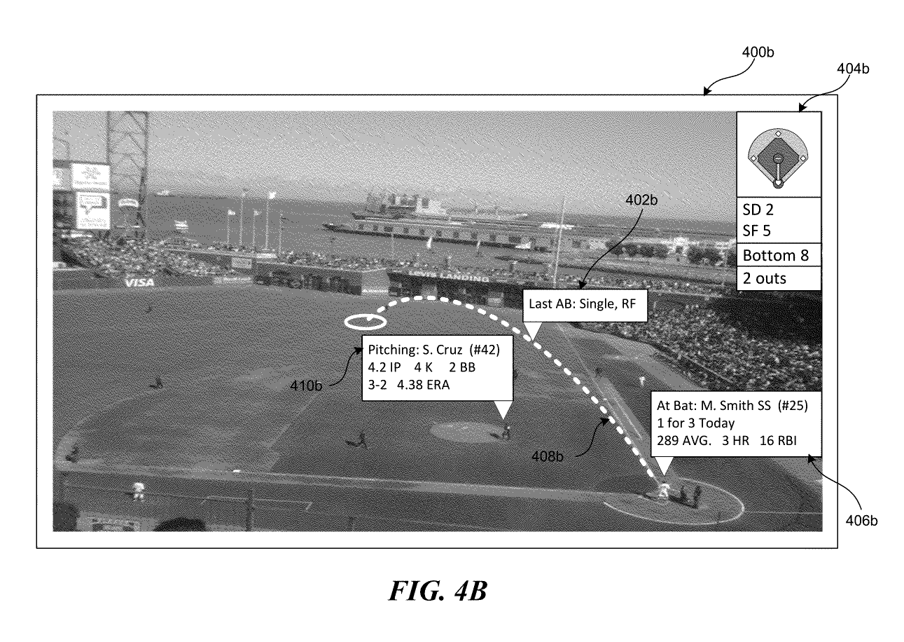

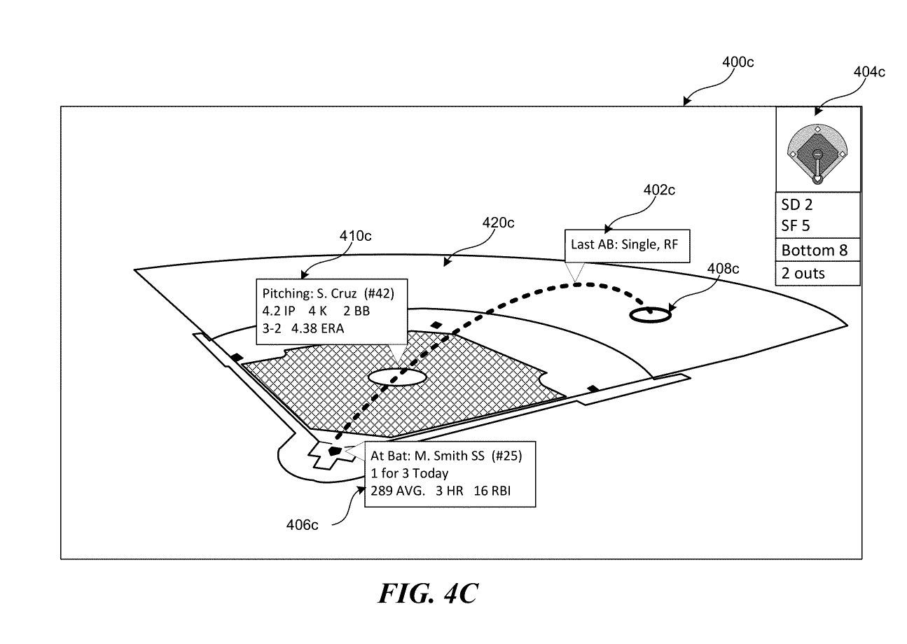

FIGS. 4A-4C provide example views that may be presented to a user via a device 102. These are described in more detail herein.

In some embodiments, the presented images in all modes may be adjusted to correct for visual impairments of the user. For example, in one embodiment, the device 102 may use retinal/optical projection technology to project images directly onto the retina of the user. The projection may be adjusted and geometrically transformed to compensate for visual impairment of the user (e.g. near sightedness). Adjustments may be made according to a known lens prescription or may be based on feedback received while using the device 102. For example, a user may adjust the presentation using an input device of device 102 to arrive at a presentation that best compensates for their visual impairment. Alternatively, an eye exam may be presented using the device 102, the results of which are utilized to adjust the presentation via the display unit.

In some embodiments the image capture device 106 includes two front facing video cameras that capture images of the physical environment surrounding the cameras which are then presented via two display devices (see. FIG. 2), thereby replicating a human stereoscopic field of vision. In some embodiments, the image capture device 106 includes more than two cameras to provide for more simultaneous angles or for a larger field of view. For example, a device 120 may include two front facing cameras, two cameras facing up, and two rear facing cameras. Alternatively, using an array of multiple cameras a partial or full 360 degree image can be captured in stereo and when the user moves their head while wearing headset 120, software can stitch together the right set of full and or partial images from available captured images.

FIG. 2 depicts a display configuration for an example head-mounted device 102. Here, device 102 includes two displays 107 that a user looks into while in use. Such a configuration combined with two front facing cameras (as shown in FIGS. 1A-1B) may provide a stereoscopic view to the user. The displays 107 themselves may be implemented as one or more liquid crystal displays (LCDs), may utilize a projected display (e.g. through a prism to redirect the projection), may project directly onto the user's eye through optical retinal projection technology, or any other technology suited to display images to the user at a relatively close proximity. It shall be understood that the configuration of device 102 shown in FIG. 2 is only an example shown for illustrative purposes. In an alternative example configuration, display 107 could be a single curved LCD wrapping across a user's field of view.

FIGS. 1A-2 depict a head mounted device 102 in the configuration of a “VR style” goggle, for illustrative purposes only. It shall be understood that device 102 may be configured differently while still being within the scope of this disclosure. For example, device 102 could be a set of smart glasses that incorporate captured images with other visual or audio information (e.g. simulated objects) in a transparent “heads-up-display.” Alternatively, device 102 may use some form of projection, or render a real world scene on a video output screen and project other information (e.g. visual information including simulated objects) onto that video screen.

FIG. 3A depicts a functional block diagram of an example system 302a for use with a head-mounted device 102, according to some embodiments. System 302a is configured to present visual and audio information (e.g. simulated objects) to a user and processes interactions with the simulated objects.

The system 302a includes a network interface 304, a timing module 306, a location sensor 308, an identification verifier module 310, an object identifier module 312, a rendering module 314, a user stimulus sensor 316, a motion/gesture sensor 318, an environmental stimulus sensor 320, and/or an audio/video output module 322. In some embodiments system 302a may include a wearable head-mounted device 102 as shown in FIGS. 1A-1B and 2. It shall be understood that a wearable device 102 may comprise one or more of the components than shown in FIG. 3A. In some embodiments, all the components may be part of a wearable head-mounted device 102. In other embodiments, device 102 may only include, for example, a rendering module 312 and audio/video output module 322. In such embodiments, device 102 may interface with other devices (e.g. a smart phone or smart watch) to access additional modules (e.g. a user stimulus sensor 316 in a smart watch device).

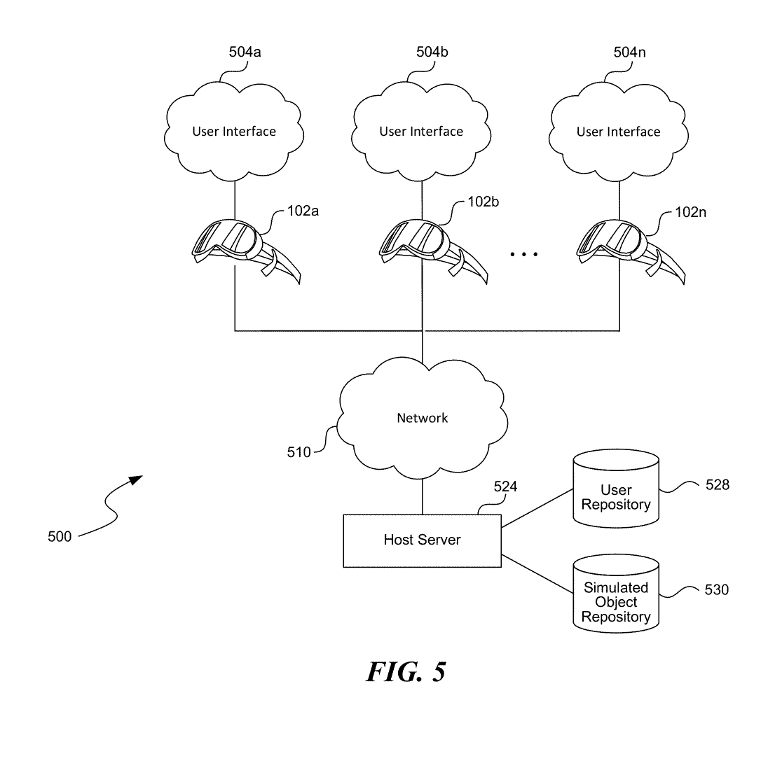

In one embodiment, the system 302a is coupled to a simulated object repository 330. The simulated object repository 330 may be internal to or coupled to the system 302a but the contents stored therein can be illustrated with reference to the example of a simulated object repository 530 described in the example of FIG. 5.

Additional or fewer modules can be included without deviating from the novel art of this disclosure. In addition, each module in the example of FIG. 3A can include any number and combination of sub-modules, and systems, implemented with any combination of hardware and/or software modules.

The system 302a, although illustrated as comprised of distributed components (physically distributed and/or functionally distributed), could be implemented as a collective element (e.g. within a wearable head-mounted device 102). In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 3A, the network interface 304 can be a networking device that enables the system 302a to mediate data in a network with an entity that is external to the host server, through any known and/or convenient communications protocol supported by the host and the external entity. The network interface 304 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

One embodiment of the system 302a includes a timing module 306. The timing module 306 can be any combination of software agents and/or hardware modules able to identify, detect, transmit, compute, a current time, a time range, and/or a relative time of a request related to simulated objects/environments.

The timing module 306 can include a local clock, timer, or a connection to a remote time server to determine the absolute time or relative time. The timing module 306 can be implemented via any known and/or convenient manner including but not limited to, electronic oscillator, clock oscillator, or various types of crystal oscillators.

In particular, since manipulations or access to simulated objects depend on a timing parameter, the timing module 306 can provide some or all of the needed timing data to authorize a request related to a simulated object. For example, the timing module 306 can perform the computations to determine whether the timing data satisfies the timing parameter of the criteria for access or creation of a simulated object. Alternatively the timing module 306 can provide the timing information to a host server to determination of whether the criteria are met.

The timing data used for comparison against the criteria can include, the time of day of a request, the date of the request, a relative time to another event, the time of year of the request, and/or the time span of a request or activity pertaining to simulated objects. For example, qualifying timing data may include the time the location of the head-mounted device 102 satisfies a particular location-based criteria.

One embodiment of the system 302a includes a location sensor 308. The location sensor 308 can be any combination of software agents and/or hardware modules able to identify, detect, transmit, compute, a current location, a previous location, a range of locations, a location at or in a certain time period, and/or a relative location of the head-mounted device 102.

The location sensor 308 can include a local sensor or a connection to an external entity to determine the location information. The location sensor 308 can determine location or relative location of the head-mounted device 102 via any known or convenient manner including but not limited to, GPS, cell phone tower triangulation, mesh network triangulation, relative distance from another location or device, RF signals, RF fields, optical range finders or grids, etc.

Since simulated objects and environments are associated with or have properties that are physical locations in the real world environment, a request pertaining to simulated objects/environments typically include location data. In some instances, access permissions of simulated objects/environments are associated with the physical location of the head-mounted device 102 requesting the access. Therefore, the location sensor 308 can identify location data and determine whether the location data satisfies the location parameter of the criteria. In some embodiments, the location sensor 308 provides location data to the host server (e.g., host server 524 of FIGS. 5-7B) for the host server to determine whether the criteria is satisfied.

The type of location data that is sensed or derived can depend on the type of simulated object/environment that a particular request relates to. The types of location data that can be sensed or derived/computed and used for comparison against one or more criteria can include, by way of example but not limitation, a current location of the head-mounted device 102, a current relative location of the head-mounted device 102 to one or more other physical locations, a location of the head-mounted device 102 at a previous time, and/or a range of locations of the head-mounted device 102 within a period of time. For example, a location criterion may be satisfied when the location of the device is at a location of a set of qualifying locations.

One embodiment of the system 302a includes an identification verifier module 310. The identification verifier module 310 can be any combination of software agents and/or hardware modules able to verify or authenticate an identity of a user.

Typically, the user's identities are verified when they generate a request pertaining to a simulated object/environment since some simulated objects/environments have user permissions that may be different for varying types of access. The user-specific criteria of simulated object access/manipulation may be used independently of or in conjunction with the timing and location parameters. The user's identity can be verified or authenticated using any known and/or convenient means.

One embodiment of the system 302a includes an object identifier module 312. The object identifier module 312 can be any combination of software agents and/or hardware modules able to identify, detect, retrieve, present, and/or generate simulated objects for presentation to a user.

The object identifier module 312, in one embodiment, is coupled to the timing module 306, the location sensor 308, and/or the identification verifier module 310. The object identifier module 312 is operable to identify the simulated objects available for access using the system 302a. In addition, the object identifier module 312 is able to generate simulated objects, for example, if qualifying location data and qualifying timing data are detected. Availability or permission to access can be determined based on location data (e.g., location data that can be retrieved or received form the location sensor 308), timing data (e.g., timing data that can be retrieved or received form the timing module 306), and/or the user's identity (e.g., user identification data received or retrieved from the identification verifier module 310)

When simulated objects are available and that the access criteria are met, the object identifier module 312 provides the simulated object for presentation to the user via the device 102. For example, the simulated object may be presented via the audio/video output module 322. Since simulated objects may be associated with physical locations in the real world environment, these objects may only be available to be presented when the device 102 is located at or near these physical locations. Similarly, since simulated objects may be associated with real objects in the real environment, the corresponding simulated objects may be available for presentation via the device 102 when near at the associated real objects.

One embodiment of the system 302a includes a rendering module 314. The rendering module 314 can be any combination of software agents and/or hardware modules able to render, generate graphical objects of any type for display via the head-mounted device 102. The rendering module 314 is also operable to receive, retrieve, and/or request a simulated environment in which the simulated object is provided. The simulated environment is also provided for presentation to a user via the head-mounted device 102.

In one embodiment, the rendering module 314 also updates simulated objects or their associated characteristics/attributes and presents the updated characteristics via the device 102 such that they can be perceived by an observing user. The rendering module 314 can update the characteristics of the simulated object in the simulated environment according to external stimulus that occur in the real environment surrounding the device 102. The object characteristics can include by way of example but not limitation, movement, placement, visual appearance, size, color, user accessibility, how it can be interacted with, audible characteristics, etc.

The external stimulus occurring in the real world that can affect characters of simulated objects can include, environmental factors in a physical location, user stimulus, provided by the user of the device 102 or another user using another device and/or at another physical location, motion/movement of the device 102, gesture of the user using the device 102. In one embodiment, the user stimulus sensor 316 receives a request from the user to perform a requested action on a simulated object and can updating at least a portion of the characteristics of the simulated object presented via the device 102 according to the effect of the requested action such that updates are perceived by the user. The user stimulus sensor 316 may determine, for example, using the identification verifier module 310, that the user is authorized to perform the requested action before updating the simulated object.

In one embodiment, the motion/gesture sensor 318 is operable to detect motion of the head-mounted device 102. The detected motion is used by the rendering module 314 to adjusting a perspective of the simulated environment presented on the device according to the detected motion of the device. Motion detecting can include detecting velocity and/or acceleration of the head-mounted device 102 or a gesture of the user handling the head-mounted device 102. The motion/gesture sensor 318 can include for example, an accelerometer.

In addition, based on updated locations of the device (e.g., periodically or continuously determined by the location sensor 308 and/or the rendering module 314), an updated set of simulated objects available for access are identified, for example, by the object identifier module 312 based on the updated locations and presented for access via the device 102. The rendering module 314 can thus update the simulated environment based on the updated set of simulated object available for access.

The environmental stimulus sensor 320 can detect environmental factors or changes in environmental factors surrounding the real environment in which the head-mounted device 102 is located. Environmental factors can include, weather, temperature, topographical characters, density, surrounding businesses, buildings, living objects, etc. These factors or changes in them can affect the positioning or characters of simulated objects and the simulated environments in which they are presented to a user via the device 102. The environmental stimulus sensor 320 senses these factors and provides this information to the rendering module 314 to update simulated objects and/or environments.

In one embodiment, the rendering module 314 generates or renders a user interface for display on via the head-mounted device 102. The user interface can include a map of the physical location depicted in the simulated environment. In one embodiment, the user interface is interactive in that the user is able to select a region on the map in the user interface. The region that is selected generally corresponds to a set of selected physical locations. The object identifier module 312 can then detect the simulated objects that are available for access in the region selected by the user for presentation via the head-mounted device 102.

The system 302 represents any one or a portion of the functions described for the modules. More or less functions can be included, in whole or in part, without deviating from the novel art of the disclosure.

FIG. 3B depicts a hardware block diagram of system suitable for use with a head-mounted display device, according to some embodiments. System 302b shown in FIG. 3B represents an alternative conceptualization of system 302a shown in FIG. 3A, however systems 302a and 302b illustrate the same functionality.

As with system 302a described in FIG. 3A, in some embodiments, all the components shown in system 302b may be part of a wearable head-mounted device 102. In other embodiments, device 102 may only include, for example, an image capture device 352 and display unit 350. In such embodiments, device 102 may interface with other devices (e.g. a smart phone or smart watch) to access additional functionality (e.g. an input device 356 in a smart watch device).

In one embodiment, system 302b includes a network interface 332, a processing unit 334, a memory unit 336, a storage unit 338, a location sensor 340, an accelerometer/motion sensor 344, an audio input/microphone unit 341, an audio output unit/speakers 346, a display unit 350, an image capture unit 352, and/or an input device 356. Additional or less units or modules may be included. The system 302b can be any combination of hardware components and/or software agents for that presenting simulated objects to a user and facilitating user interactions with the simulated objects. The network interface 332 has been described in the example of FIG. 3A.

One embodiment of the system 302b further includes a processing unit 334. The location sensor 340, motion sensor 342, and timer 344 have been described with reference to the example of FIG. 3A.

The processing unit 334 can include one or more processors, CPUs, microcontrollers, FPGAs, ASICs, DSPs, or any combination of the above. Data that is input to the system 302b for example, via the image capture unit 352, and/or input device 356 (e.g., touch screen device) can be processed by the processing unit 334 and output to the display unit 350, audio output unit/speakers 346 and/or output via a wired or wireless connection to an external device, such as a host or server computer that generates and controls access to simulated objects by way of a communications component.

One embodiment of the system 302b further includes a memory unit 336 and a storage unit 338. The memory unit 336 and a storage unit 338 are, in some embodiments, coupled to the processing unit 334. The memory unit can include volatile and/or non-volatile memory. In generating and controlling access to the simulated objects, the processing unit 334 may perform one or more processes related to presenting simulated objects to a user and/or facilitating user interactions with the simulated objects.

The input device 356 may include touch screen devices, buttons, microphones, sensors to detect gestures by a user, or any other devices configured to detect an input provided by a user.

The image capture device may be the same as image capture device 106 illustrated in FIGS. 1A-1B. In some embodiments image capture devices 352 may include one or more video cameras mounted to the outside of the head-mounted device 102. For example, to provide stereoscopic vision via displays associated with head-mounted device 102, two image capture devices 352 may be mounted with a specific separation as shown in FIGS. 1A-1B. Alternatively, image capture device 352 may include more than two video cameras to provide for more simultaneous angles or for a larger field of view. As an example, a head-mounted device 102 may include two cameras facing forward, two cameras facing up and two cameras facing the rear (not shown in the FIGS.). Image capture device 352 may be configured to capture visible light and/or light outside the visible spectrum (e.g. infrared or ultraviolet. Captured images may also be processed (e.g. by processing unit 334) by software (e.g. stored in memory unit 336) in real time or near real time to apply filters or transformations or any other adjustments to the images.

The audio output/speaker device 246 may be configured to present audible information to the user.

The audio input/microphone unit 341 may be configured to capture mono, stereo or three-dimensional audio signals in the surrounding physical environment. Captured audio signals may be processed and presented to the user as audible information via audio output/speaker unit 346. In some embodiments, audio input/microphone unit 341 is not attached to head-mounted device 102 and instead is associated with another device. For example, audio captured by a microphone in a smart phone device may be received by the head-mounted display device 102 and presented via audio output/speaker unit 346.

The image capture unit 352 and audio input unit/microphone 341 may be conceptualized collectively as ‘sensors’ configured to gather sensor data, specifically user perceptible sensor data (e.g. visual and audible) from the physical environment. Similarly, display unit 350 and audio output unit/speaker 346 may be conceptualized collectively as a sensory output units configured to present sensory output information (e.g. visual or audible information) to a user of a head-mounted device 102.

In some embodiments, any portion of or all of the functions described of the various example modules in the system 302a of the example of FIG. 3A can be performed by the processing unit 334. In particular, with reference to the client device illustrated in FIG. 3A, the timing module, the location sensor, the identification verifier module, the object identifier module, the rendering module, the user stimulus sensor, the motion gesture sensor, the environmental stimulus sensor, and/or the audio/video output module can be performed via any of the combinations of modules in the control subsystem that are not illustrated, including, but not limited to, the processing unit 334 and/or the memory unit 336.

FIGS. 4A-4C depict views (i.e. visual information) that may be presented to a user while wearing a head-mounted device 102 in each of three different modes.

FIG. 4A depicts a user view 400a that may be presented to the user via a display device while in a reality user interaction mode. In FIG. 4A the user is seated at a baseball game. Accordingly, the view 400a presented is merely a live video feed of the surrounding physical environment captured by the external cameras. As discussed previously, while in reality mode, the presented view may be processed or transformed in some way to improve visibility, for example by lowering brightness, increasing contrast, or applying filters, to counter glare on a sunny day.

Not shown in FIG. 4A is audio output information that may be presented to a user via an audio output/speaker device associated with head-mounted device 102. Similar to the visual information, while in a reality interaction mode, audio information may include only a live audio feed from one or more audio input/microphone devices situated to capture audio in the physical environment surrounding the user.

FIG. 4B depicts a user view 400b that is presented to the user via a display device while in an augmented reality user interaction mode. As in FIG. 4A, in FIG. 4B the user is also seated at the baseball game. Here, the live video feed of the surrounding physical environment is supplemented with one or more simulated objects 402b-410b. Simulated objects may be presented as graphical overlays that include data pulled from a network, for example, info on the last at bat by the current batter (simulated object 402b), the current score and inning (simulated object 404b), statistics on the current batter (simulated object 406b), a traced trajectory of the last hit by the current batter (simulated object 408b), and statistics on the current pitcher (simulated object 410b). As will be described in greater detail later, access to simulated objects may be based in part on location data and/or time data. In the example of FIG. 4A, the device 102 may include location sensors (e.g. similar to location sensors 340 in FIG. 3B) that gather location data including a current location of the device 102. Based on the location data, simulated objects are detected, retrieved, generated, and presented relative to the location of physical objects in the physical environment. For example, simulated object 406b, because it relates to the current batter, is presented in view 400b relative to the physical location of the current batter. If the user were to turn away or walk out of the stadium, simulated object 406b would no longer be accessible via device 102. Similarly, access may be based on time data. A time module (discussed in more detail herein) may gather data associated with an absolute time or a time relative to the current position of the device 102. Access to simulated objects may similarly be dependent on the time data. For example, an advertisement (not shown) may be presented as a simulated object via view 400b at a predetermined time or between innings.

Not shown in FIG. 4B is audio information that may be presented to the user via an audio output/speaker device. Here, while in an augmented reality mode, audio information may include live audio feed from one or more audio input/microphone devices situated to capture audio in the physical environment surrounding the user, audio from one or more audio input/microphone devices at a remote location (e.g. an audio feed from a radio broadcast associated with the game or pre-recorded music or commentary), and/or computer-generated audio not from an audio input device (e.g. overlaid audio special effects).

FIG. 4C depicts a user view 400c that is presented to the user via a display device while in a virtual reality user interaction mode. Unlike the views 400a and 400b shown in FIGS. 4A and 4B (respectively), view 400c presents a virtual reality made up of a computer simulated environment of computer simulated objects. In other words, view 400c does not incorporate live video from external cameras associated with the head-mounted device 102. For example, as shown in FIG. 4C, view 400c includes a computer generated or simulated environment made of simulated objects like the computer generated baseball diamond 420c and various other simulated objects 402c-410c. In this example, simulated object 402c-410c correspond with simulated objects 402b-410b as shown in FIG. 4B because view 400c is presenting the same baseball game as shown in view 400b of FIG. 4B. However, because view 400c is presenting a virtual reality of the game, the user need not be at the baseball game with the field in view of the cameras associated with the head-mounted device 102. Instead the user might be at home watching the game. It is important to note that the environment need not be computer generated while in virtual reality mode, only that it is not associated with the physical reality around the user as captured by the image capture devices associated with the head-mounted device. For example, the user may be at home and receiving a live video feed in stereoscopic 3D from a television broadcast captured at the baseball game. The simulated environment in this example is based on the live video feed from the remote location (the ballpark) and not a video feed from the image capture devices associated with the head-mounted device 102. Not shown in FIG. 4B is audio information that may be presented to the user via an audio output/speaker device. Here, while in an augmented reality mode, audio information may include live audio feed from one or more audio input/microphone devices situated to capture audio in the physical environment surrounding the user, audio from one or more audio input/microphone devices at a remote location (e.g. an audio feed from a radio broadcast associated with the game or pre-recorded music or commentary), and/or computer-generated audio not from an audio input device (e.g. overlaid audio special effects).

User Interaction with Simulated Objects Presented Via a Head-Mounted Display/Camera System

FIG. 5 depicts a lock diagram of an example system 500 including client devices 102A-N able to communicate with a host server 524 that generates and controls access to simulated objects through a network 510.

The devices 102A-N may be the wearable head-mounted display device as described with respect to FIGS. 1A-3B although may also be any system and/or device, and/or any combination of devices/systems that is able to establish a connection with another device, a server and/or other systems. As described, the devices 102A-N typically include a display and/or other output functionalities to present information and data exchanged between among the devices 102A-N and the host server 524. The devices 102A-N may be location-aware devices that are able to determine their own location or identify location information from an external source. In one embodiment, the devices 102A-N are coupled to a network 510.

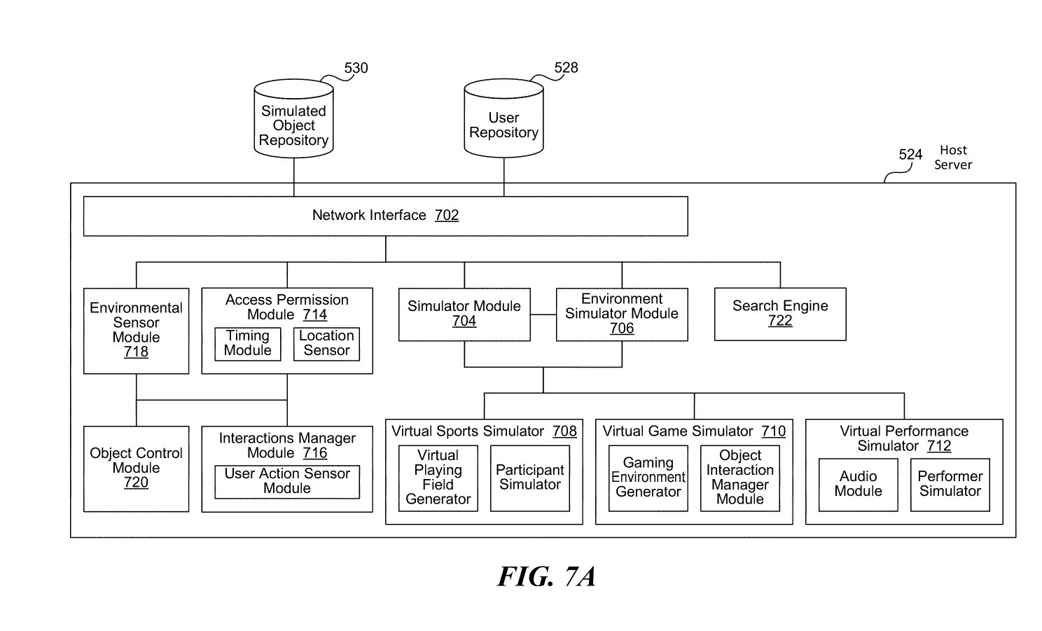

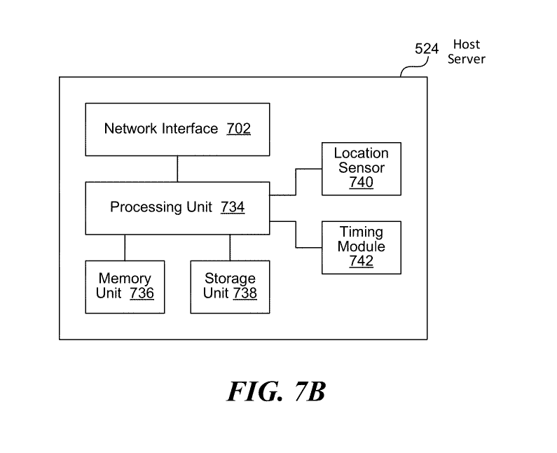

In one embodiment, the host server 524 is operable to provide simulated objects (e.g., objects, computer-controlled objects, or simulated objects), some of which that correspond to real world physical locations, to be presented to users on client devices 102A-N, for example as shown in FIGS. 4A-4C. The simulated objects are typically software entities or occurrences that are controlled by computer programs and can be generated upon request from one or more of the devices 102A-N. The host server 524 also processes interactions of simulated object with one another and actions on simulated objects caused by stimulus from a real user and/or the real world environment. Services and functions provided by the host server 524 and the components therein are described in detail with further references to the examples of FIGS. 7A-7B.

The client devices 102A-N are generally operable to provide access (e.g., visible access, audible access, interactive access, etc.) to the simulated objects to users, for example via user interfaces 504A-N displayed on the display units. The devices 102A-N may be able to detect the availability of simulated objects based on location and/or timing data and provide those objects authorized by the user for access via the devices. Services and functions provided by the devices 102A-N and the components therein are described in detail with further references to the examples of FIGS. 3A-3B.

The network 510, over which the client devices 102A-N and the host server 524 communicate, may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 510 can be any collection of distinct networks operating wholly or partially in conjunction to provide connectivity to the devices 102A-N and the host server 524 and may appear as one or more networks to the serviced systems and devices. In one embodiment, communications to and from the devices 102A-N can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WW AN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCPIIP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 524 may include or be coupled to a user repository 528 and/or a simulated object repository 530. The user data repository 528 can store software, descriptive data, images, system information, drivers, and/or any other data item utilized by other components of the host server 524 and/or any other servers for operation. The user data repository 528 may be managed by a database management system (DBMS), for example but not limited to, Oracle, DB2, Microsoft Access, Microsoft SQL Server, PostgreSQL, MySQL, FileMaker, etc.

The user data repository 528 and/or the simulated object repository 530 can be implemented via object-oriented technology and/or via text files, and can be managed by a distributed database management system, an object-oriented database management system (OODBMS) (e.g., ConceptBase, FastDB Main Memory Database Management System, JDOinstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 524 is able to provide data to be stored in the user data repository 528 and/or the simulated object repository 530 and/or can retrieve data stored in the user data repository 528 and/or the simulated object repository 530. The user data repository 528 can store user information, user preferences, access permissions associated with the users, device information, hardware information, etc. The simulated object repository 530 can store software entities (e.g., computer programs) that control simulated objects and the simulated environments in which they are presented for visual/audible access or control/manipulation. The simulated object repository 530 may further include simulated objects and their associated data structures with metadata defining the simulated object including its associated access permission.

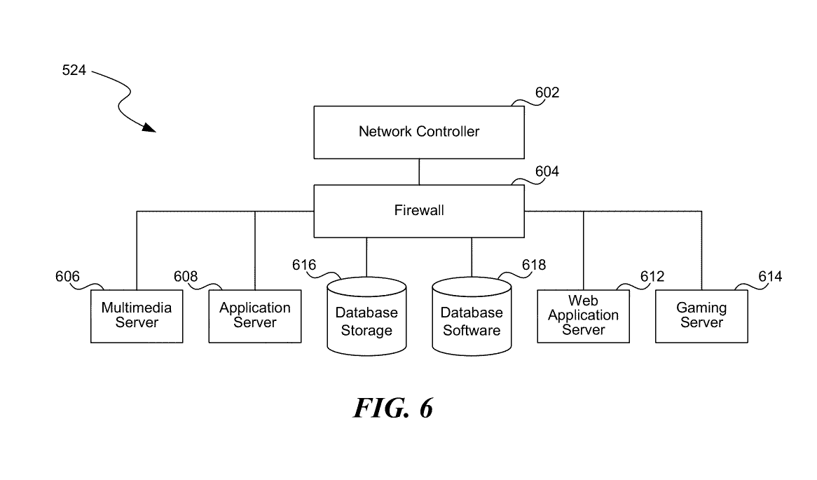

FIG. 6 depicts a block diagram of the components of a host server 524 that generates and controls simulated objects for access via a head-mounted device 102.

In the example of FIG. 6, the host server 524 includes a network controller 602, a firewall 604, a multimedia server 606, an application server 608, a web application server 612, a gaming server X14, and a database including a database storage 616 and database software 618.

In the example of FIG. 6, the network controller 602 can be a networking device that enables the host server 524 to mediate data in a network with an entity that is external to the host server 524, through any known and/or convenient communications protocol supported by the host and the external entity. The network controller 602 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

In the example of FIG. 6, the network controller 602 can be a networking device that enables the host server 524 to mediate data in a network with an entity that is external to the host server 524, through any known and/or convenient communications protocol supported by the host and the external entity. The network controller 602 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The firewall 604, can, in some embodiments, govern and/or manage permission to access/proxy data in a computer network, and track varying levels of trust between different machines and/or applications. The firewall 604 can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall 604 may additionally manage and/or have access to an access control list which details permissions including for example, the access and operation rights of an object by an individual, a machine, and/or an application, and the circumstances under which the permission rights stand.

Other network security functions can be performed or included in the functions of the firewall 604, can be, for example, but are not limited to, intrusion-prevention, intrusion detection, next-generation firewall, personal firewall, etc. without deviating from the novel art of this disclosure. In some embodiments, the functionalities of the network controller 602 and the firewall 604 are partially or wholly combined and the functions of which can be implemented in any combination of software and/or hardware, in part or in whole.

In the example of FIG. 6, the host server 524 includes the multimedia server 606 or a combination of multimedia servers to manage images, photographs, animation, video, audio content, graphical content, documents, and/or other types of multimedia data for use in or to supplement simulated content such as simulated objects and their associated deployment environment (e.g., a simulated environment). The multimedia server 606 is any software suitable for delivering messages to facilitate retrieval/transmission of multimedia data among servers to be provided to other components and/or systems of the host server 524, for example, when rendering a web page, a simulated environment, and/or simulated objects including multimedia content.

In addition, the multimedia server 606 can facilitate transmission/receipt of streaming data such as streaming images, audio, and/or video. The multimedia server 606 can be configured separately or together with the web application server 612, depending on a desired scalability of the host server 524. Examples of graphics file formats that can be managed by the multimedia server 606 include but are not limited to, ADRG, ADRI, AI, GIF, IMA, GS, JPG, JP2, PNG, PSD, PSP, TIFF, and/or BMP, etc.

The application server 608 can be any combination of software agents and/or hardware modules for providing software applications to end users, external systems and/or devices. For example, the application server 608 provides specialized or generic software applications that manage simulated environments and objects to devices (e.g., client devices). The software applications provided by the application server 608 can be automatically downloaded on-demand on an as-needed basis or manually at the user's request. The software applications, for example, allow the devices to detect simulated objects based on the location of the device and to provide the simulated objects for access, based on permissions associated with the user and/or with the simulated object.

The application server 608 can also facilitate interaction and communication with the web application server 612, or with other related applications and/or systems. The application server 608 can in some instances, be wholly or partially functionally integrated with the web application server 612.

The web application server 612 can include any combination of software agents and/or hardware modules for accepting Hypertext Transfer Protocol (HTTP) requests from end users, external systems, and/or external client devices and responding to the request by providing the requestors with web pages, such as HTML documents and objects that can include static and/or dynamic content (e.g., via one or more supported interfaces, such as the Common Gateway Interface (CGI), Simple CGI (SCGI), PHP, JavaServer Pages (JSP), Active Server Pages (ASP), ASP.NET, etc.).

In addition, a secure connection, SSL and/or TLS can be established by the web application server 612. In some embodiments, the web application server 612 renders the user interfaces having the simulated environment as shown in the example screenshots of FIGS. 4A-4C. The user interfaces provided by the web application server 612 to client users/end devices provide the user interface screens 104A-104N for example, to be displayed on client devices 102A-102N. In some embodiments, the web application server 612 also performs an authentication process before responding to requests for access, control, and/or manipulation of simulated objects and simulated environments.

In one embodiment, the host server 524 includes a gaming server 614 including software agents and/or hardware modules for providing games and gaming software to client devices. The games and gaming environments typically include simulations of real world environments. The gaming server 614 also provides games and gaming environments such that the simulated objects provided therein have characteristics that are affected and can be manipulated by external stimuli (e.g., stimuli that occur in the real world environment) and can also interact with other simulated objects. External stimuli can include real physical motion of the user, motion of the device, user interaction with the simulated object on the device, and/or real world environmental factors, etc.

For example, the external stimuli detected at a client device may be converted to a signal and transmitted to the gaming server 614. The gaming server 614, based on the signal, updates the simulated object and/or the simulated environment such that a user of the client device perceives such changes to the simulated environment in response to real world stimulus. The gaming server 614 provides support for any type of single player or multiplayer electronic gaming, PC gaming, arcade gaming, and/or console gaming for portable devices or non-portable devices. These games typically have real world location correlated features and may have time or user constraints on accessibility, availability, and/or functionality. The objects simulated by the gaming server 614 are presented to users via devices and can be controlled and/or manipulated by authorized users.

The databases 616, 618 can store software, descriptive data, images, system information, drivers, and/or any other data item utilized by other components of the host server for operation. The databases 616, 618 may be managed by a database management system (DBMS), for example but not limited to, Oracle, DB2, Microsoft Access, Microsoft SQL Server, PostgreSQL, MySQL, FileMaker, etc. The databases 616, 618 can be implemented via object-oriented technology and/or via text files, and can be managed by a distributed database management system, an object-oriented database management system (OODBMS) (e.g., ConceptBase, FastDB Main Memory Database Management System, JDOinstruments, ObjectDB, etc.), an object-relational database management system (ORDBMS) (e.g., Informix, OpenLink Virtuoso, VMDS, etc.), a file system, and/or any other convenient or known database management package.

In the example of FIG. 6, the host server 524 includes components (e.g., a network controller, a firewall, a storage server, an application server, a web application server, a gaming server, and/or a database including a database storage and database software, etc.) coupled to one another and each component is illustrated as being individual and distinct. However, in some embodiments, some or all of the components, and/or the functions represented by each of the components can be combined in any convenient or known manner. Furthermore, the functions represented by the devices can be implemented individually or in any combination thereof, in hardware, software, or a combination of hardware and software.

FIG. 7A depicts a functional block diagram of an example host server 524 that generates and controls access to simulated objects.

The host server 524 includes a network interface 702, a simulator module 704, an environment simulator module 706, a virtual sports simulator 708, a virtual game simulator 710, a virtual performance simulator 712, an access permission module 714, an interactions manager module 716, an environmental factor sensor module 718, an object control module 720, and/or a search engine 722. In one embodiment, the host server 524 is coupled to a user data repository 528 and/or a simulated object repository 530. The user data repository 528 and simulated object repository 530 are described with further reference to the example of FIG. 5.

Additional or fewer modules can be included without deviating from the novel art of this disclosure. In addition, each module in the example of FIG. 7 can include any number and combination of sub-modules, and systems, implemented with any combination of hardware and/or software modules.

The host server 324, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 7A, the network interface 702 can be a networking device that enables the host server 524 to mediate data in a network with an entity that is external to the host server, through any known and/or convenient communications protocol supported by the host and the external entity. The network interface 702 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

One embodiment of the host server 524 includes a simulator module 704. The simulator module 704 can be any combination of software agents and/or hardware modules able to create; generate, modify, update, adjust, edit, and/or delete a simulated object.

As used in this specification, simulated objects may be broadly understood as any object, entity, element, information etc. that is created, generated, rendered, presented, or otherwise provided using a computer or computing device. Simulated objects may include, but are not limited to an audio or visual representation of data (e.g. a graphical overlay, or audio output), a computer simulation of a real or imaginary entity, concept/idea, occurrence, event, or any other phenomenon with human perceptible (e.g. audible and/or visible) characteristics that can be presented to a user via a display device and/or and audio output/speaker device.

In some embodiments, simulated objects are associated with physical locations in the real world environment and have associated accessibilities based on a spatial parameter (e.g., the location of a device through which the simulated object is to be accessed). In some instances, the simulated objects have associated accessibilities based on a temporal parameter as well as user specificities (e.g., certain users may be different access rights to different simulated objects).

Characteristics and attributes of simulated objects can be perceived by users in reality via a physical device (e.g., device 102 in the example of FIGS. 1-2. For example, a simulated object typically includes visible and/or audible characteristics that can be perceived by users via a device with a display and/or a speaker. Changes to characteristics and attributes of simulated objects can also be perceived by users in reality via physical devices.

In one embodiment, these simulated objects are associated with physical locations in the real world environment and have associated accessibilities based on a spatial parameter (e.g., the location of a device through which the simulated object is to be accessed). In some instances, the simulated objects have associated accessibilities based on a temporal parameter as well as user specificities (e.g., certain users may be different access rights to different simulated objects).

Objects may be simulated by the simulator module 704 automatically or manually based on a user request. For example, objects may be simulated automatically when certain criterion (e.g., qualifying location data and/or qualifying timing data) are met or upon request by an application. Objects may also be newly created/simulated when an authorized user requests objects that are not yet available (e.g., object is not stored in the simulated object repository 530). Generated objects can be stored in the simulated object repository 530 for future use.

In one embodiment, the simulated object is implemented using a data structure having metadata. The metadata can include a computer program that controls the actions/behavior/properties of the simulated object and how behaviors of the simulated object are affected by a user or other external factors (e.g., real world environmental factors). The metadata can also include location and/or timing parameters that include the qualifying parameters (e.g., qualifying timing and/or location data) that satisfy one or more criteria for access of the simulated object to be enabled. The location data can be specified with longitude and latitude coordinates, GPS coordinates, and/or relative position. In one embodiment, the object is associated with a unique identifier. The unique identifier may be further associated with a location data structure having a set of location data that includes the qualifying location data for the simulated object.

The metadata can include different criteria for different types of access of the simulated object. The different types of accessibility can include, create, read, view, write, modify, edit, delete, manipulate, and/or control etc. Each of these actions can be associated with a different criterion that is specified in the object's metadata. In addition to having temporal and spatial parameters, some criterion may also include user-dependent parameters. For example, certain users have edit right where other users only have read/viewing rights. These rights may be stored as user access permissions associated with the user or stored as object access permission rights associated with the simulated object. In one embodiment, the metadata includes a link to another simulated object and/or data from an external source (e.g., the Internet, Web, a database, etc.). The link may be a semantic link.

One embodiment of the host server 524 includes an environment simulator module 706. The environment simulator module 706 can be any combination of software agents and/or hardware modules able to generate, modify, update, adjust, and/or delete a simulated environment in which simulated objects are presented. For example, when a head-mounted device 102 is operating in a VR mode instead of an AR mode.

In some embodiments a simulated environment may comprise a collection of simulated objects as described earlier in the specification.

In one embodiment, the simulated environment is associated with a physical location in the real world environment. The simulated environment thus may include characteristics that correspond to the physical characteristics of the associated physical location. One embodiment of the host server 524 includes the environment simulator module 706 which may be coupled to the simulator module 704 and can render simulated environments in which the simulated object is deployed.

The simulated objects are typically visually provided in the simulated environment for display on a device display. Note that the simulated environment can include various types of environments including but not limited to, a gaming environment, a virtual sports environment, a virtual performance environment, a virtual teaching environment, a virtual indoors/outdoors environment, a virtual underwater environment, a virtual airborne environment, a virtual emergency environment, a virtual working environment, and/or a virtual tour environment.

For example, in a simulated environment with a virtual concert that is visible to the user using a device, the simulated objects in the virtual concert may include those controlled by a real musician (e.g. recorded or in real time). Other simulated objects in the virtual concert may further include simulated instruments with audible characteristics such as sound played by the real instruments that are represented by the simulated instruments. Additional simulated objects may be provided in the virtual concert for decorative purposes and/or to provide the feeling that one is in a real concert. For example, additional simulated objects may include a simulated audience, a simulated applause, etc.

In one example, the simulated environment is associated with a physical location that is a tourist location in the real world environment. The simulated object associated with the tourist location can include video and audio data about the tourist location. The audio data can include commentary about the historical value of the site. The simulated object may also include a link to other simulated objects corresponding to other nearby tourist attractions or sites and serve as a self-serve travel guide or personal travel agent.

In one embodiment, this information is automatically provided to the user when he or she arrives at or near the real world tourist location (e.g., implicit request) via the device. Alternatively, the information is provided upon request by the user (e.g., explicit request). For example, simulated objects associated with various attractions in the tourist location in the real world can be selected by the user (e.g., via input to the device). The simulated objects that are selected may perform playback of the textual, video and/or audio data about the attractions in the real world tourist location.

In one example, the simulated object is an advertisement (e.g., an electronic advertisement) and the user to whom the simulated object is presented is a qualified user targeted by the advertisement. The user may qualify on a basis of a location, identity, and/or a timing parameter. For example, the user may be provided with advertisements of local pizza shops or other late night dining options when the user is driving around town during late night hours when other dining options may not be available.

In one example, the simulated environment is used for education and training of emergency services providers and/or law enforcement individuals. These simulated environments may include virtual drills with simulated objects that represent medical emergencies or hostages. The users that access these simulated virtual drills may include medical service providers, firefighters, and/or law enforcers.

In a further example, simulated objects can represent electronic documents (e.g., files or datasets) that are visible using the device when the device is in a particular physical location in the real world environment. For example, a document or note can be left for a user at a simulated location that corresponds to a real world location. In one embodiment, the simulated object represents an electronic document and the user retrieves the electronic document using the device when the location of the device satisfies a criteria. For example, the electronic document is a reference manual for a physical object and can be accessible to the user when the location of the device is within a range of the physical object.

In another example, simulated objects with access permissions that on spatial and temporal parameters can be used to data protection. The simulated object that represents the protected data may only be viewed using devices located at an authorized location or in an authorized facility. The user viewing the protected data may also be an authorized user. Thus, the protected data cannot be viewed by anyone outside the authorized location/facility or by anyone that is not authorized. The protected data may only be viewed during a certain period of time.

In one example, the simulated environment is a virtual desktop that includes simulated objects. The simulated objects may be associated with real physical locations near a user and be placed in space relative to the user. In one embodiment, access to the simulated objects may be enabled for those associated with the real physical locations visible through an imaging unit of the device (e.g., an image capture device of the head-mounted display device 102). For example, when a user views physical space with a camera on head-mounted display device 102, the user can see the simulated objects displayed via a virtual desktop displayed via the head-mounted display device 102. The virtual desktop appears to the user as if it is in the surrounding space and may include features that correspond to the real surrounding space. The device can be moved in space such that different simulated objects associated with different physical locations are imaged through the cell phone camera and thus accessed.

In another example, a simulated environment can be used for task management. For example, the simulated object can represent or include information related to a task. The simulated tasks can be presented to the user through the device when located at or near the location where the task is to be performed. For example, information about deliveries can be placed for a driver at various real world delivery locations. Thus, the driver can be notified of this information on their devices when they arrive at the delivery locations. The information more relevant to their present location can be displayed as more visible or prominent with higher priority in the user interface displayed on the device.

In one embodiment, the simulated object is a virtual personal assistant of the user. The virtual personal assistant can be pre-programmed or configured to follow the user around as they move around in real physical space. The virtual personal assistant may be visible to the user via the device anywhere they go. The virtual personal assistance may also be visible to others via devices with access permissions.

The simulated environment may be a virtual marketplace associated with the physical location in the real world environment. The simulated objects and represent either real goods or virtual goods for users to sell or purchase when the device is located in the physical location associated with the virtual market place. In general, users with a device with the appropriate software capabilities and/or proper access permissions can see the simulated objects and buy or sell the corresponding goods.

In one embodiment, the simulated object represents an electronic coupon and is accessible to a user using the device when the device is located at the location during a certain period of time that satisfies the criteria. The electronic coupon may be redeemed by the user at a business located at or near the location in the real world environment.

One embodiment of the host server 524 includes an access permission module 714. The access permission module 714 can be any combination of software agents and/or hardware modules able to determine availability and accessibility of a simulated object based on a criterion.

The criteria can include spatial-temporal criteria having a timing parameter and/or a location parameter. For example, a simulated object may be associated with a physical location in the real world environment. The location parameter may include a set of locations including the physical location and/or surrounding regions where the device is to be located to access the simulated object. In addition, the timing parameter includes a time or set of times when the simulated object can be accessed. The timing parameter and the location parameter can be used independently or in conjunction with each other.

The access permission module 714 can determine whether a location data and/or a timing data satisfy the criterion (e.g., a spatial-temporal criterion). The access permission module 714 is coupled to the simulator module 704, the environment simulator module 706, and the simulated object repository 530, where simulated objects and/or simulated environments are stored. When the access permission module 714 determines that the location and/or timing data satisfy the criterion, the access permission module 714 access of the simulated object in a simulated environment by a user via a device (e.g., portable or non-portable device). One embodiment of the access permission module 714 includes a timing module and a location sensor to determine the current time and/or the current location of a device.

In one embodiment, location data and/or the timing data that satisfy the criterion include the location of the device and the time the device is located at the location. The enable signal may be sent to the simulator and environmental simulator modules such that the simulator module 704 an enable access to the simulated object via a device when the criteria is met. The access permission module 714 may retrieve the relevant simulated objects and simulated environments from other modules to be provided to a user via a device.

In one embodiment, the access permission module 714 determines the criterion associated with the simulated objects, for example, by retrieving and/or identifying metadata stored in the data structure of the simulated object that specifies qualifying timing data and/or qualifying location data that satisfy the criteria for object access. In addition, the access permission module 714 can set the access criteria for a simulated object. For example, the access permission module 714 can identify metadata of the simulated object and determine various attributes of the simulated object to set some access criteria.

The access permission module 714 can also identify the user access permission associated with a particular user. For example, the access permission module 714 can retrieve user information from the user repository 528. The user repository can be coupled to the simulated object repository 530 and can have stored therein access permissions associated with the user. Thus, the criterion to access a simulated object can further include a user-dependent parameter.

One embodiment of the host server 724 includes an interactions manager module 716. The interactions manager module 716 can be any combination of software agents and/or hardware modules able to monitor, manage, control user interactions and user requested interactions with the simulated objects, and interactions among simulated objects.

The interactions manager module 716 can be coupled to the access permission module 714 to determine the criteria for interacting with the simulated objects and whether the requesting user has permission to perform such requested actions on the simulated objects. The interactions manager module 716, upon receiving a request from the user to perform a requested action on the simulated object, the manager module 716 determines whether the user is permitted to perform the requested action on the simulated object.

The interactions manager module 716 can identify this information according to either user access permissions and/or object access permissions. The requested action is typically triggered by the user via the device (e.g., head mounted device 102) using input control via an input device 356 (e.g., a button or touch screen device) of the device 102.

If the user is permitted to interact with the simulated object, the manager module 716 can perform the requested action on the simulated object by updating stored attributes of the simulated objects and presenting the updated attributes via the device to be perceived by the user. In one embodiment, the simulator module 704 updates the attributes according to the requested action upon receiving the commands or signals. The user requested actions can include, by way of example but not limitation, collecting an item (e.g., a reward), firing ammunition, throwing an item, eating an item, attending an event, dialoguing with another character (real or virtual), surmounting a barrier, hitting a ball, blocking a ball, kicking a ball, and/or shooting a goblin, etc. These actions may be requested by the user using an input device or a combination of input devices.

Note that user actions requested with regards to simulated objects can be stored, for later access or to compute statistics regarding usage, likeability, user preference, etc. User actions requested pertaining to simulated objects an include one or more of, adding as a favorite and collecting as a bookmark, sharing the simulated object, flagging the simulated object, and/or tagging the simulated object. Additionally, user-generated data for simulated objects can also be recorded and stored. User-generated data an include, one or more of, modification of the simulated object, comment on the simulated object, review of the simulated object, and/or rating of the simulated object. In some embodiments, the user modifies the simulated object using the device or another device. In addition, the user can create or author the simulated object using any device.

Simulated objects may interact with one another. The interactions manager module 316 can control these interactions according to the computer programs that control the simulated objects. The simulated objects that interact with one another may be controlled/manipulated by real users and/or wholly/partially controlled by computer programs.

One embodiment of the host server 524 includes an environmental sensor module 718. The environmental sensor module 718 can be any combination of software agents and/or hardware modules able to detect, sense, monitor, identify, track, and/or process environmental factors, physical characteristics and changes that occur in the real world environment.

Since simulated environments can be sometimes thought not always generated to correspond to simulation of a physical location in a real world environment and/or regions proximal to the physical location, the environmental sensor module 718 can detect and sense the environmental factors and physical characteristics in the real world to facilitate such interactions. The environmental sensor module 718 is coupled to the environment simulator module 706 and can provide such information to the environmental simulator module 706 such that simulated environments, when generated, will correspond to simulation of the physical location and regions proximal to the physical location.

In one embodiment, simulated objects and their associated characteristics depend on stimuli that occur in the real world environment. For example, the external stimuli that can change/affect behaviors or appearances of a simulated object include environmental factors in or near the physical location associated with the simulated object. The environmental sensor module 718 can detect these environmental factors and changes and communicate the information to the simulator module 704 and/or the environmental simulator module 706 to implement the effects of the environmental factors on the simulated object in software for presentation via devices.

The environmental factors detected by the environmental sensor module 718 can include, by way of example but not limitation, temperature, weather, landscape, surrounding people, cars, animals, climate, altitude, topology, population, etc.

One embodiment of the host server 524 includes an object control module 720. The object control module 720 can be any combination of software agents and/or hardware modules able to manage the control of simulated objects by real users in the real world environment.

Simulated objects, in addition to being manipulated and interacted with by users, can also be “controlled” by users. In a simulated environment, there may be simulated objects some of which are controlled by different users in different physical locations, for example. Control of a simulated object by a user can be defined more broadly than manipulation of or interaction with a simulated object. For example, the movements, behaviors, and/or actions of a simulated object can be simulations of movement, behaviors, and/or actions of a real user.

The movement trajectory of the simulated object in a simulated environment, when controlled by a user, can be predominantly governed by movement or behavior of the user. In a further example, the form/shape of the simulated object may also depend on the physical appearances of the users. In addition, the simulated object may include audible characteristics that depend on the user's voice or speech.

The object control module 720 determines permissions of users to control the simulated object. Changes to attributes of the simulated object caused by user control can be reflected in the simulated environment and perceived by the same controlling user or other users via a device. This update can occur with a delay or in real-time/near real-time. In addition, other simulated objects may be controlled by other users (e.g., located in the same or different physical location) and the changes to attributes of the simulated object caused by control of another user is reflected in the simulated environment and perceived by the user or other users using one or more devices.

One embodiment of the host server 524 includes a virtual sports simulator 708. The virtual sports simulator 708 can be any combination of software agents and/or hardware modules able to simulate a virtual sports game that is played by a real participant in a real world environment.

The virtual sports simulator 708 is coupled to the simulator module 704 and the environment simulator module 706. In one embodiment, the virtual sports simulator 708 can generate a simulated playing field that represents a physical location in the real world environment. The simulated playing field generally has characteristics that correspond to the physical characteristics of the physical location where the real participant is located. For example, if the real participant is located in a real park, the simulated playing field may include a grass field with trees and benches. In addition, the size of the simulated playing field can be determined based on a size of the physical location. One embodiment of the virtual sports simulator 708 includes a virtual playing field generator.

The virtual sports game can be solo or team sports games. For example, the virtual sports game can be a simulation of virtual golf in a downtown square or a virtual baseball game on a crowded street corner. Even though the real street corner may not have enough room for an actual physical baseball game, the real participants can stand in various locations with their devices (e.g., mobile devices or location-aware devices) and the simulated playing field can automatically resize and readjust based on the size and other characteristics of the street corner in the real environment.

In one embodiment, the virtual sports simulator 708 identifies the user requested action to be performed on a simulated object in the simulated playing field by detecting user interaction with the device or by receiving data indicating the nature of the interaction of the requested action. In general, a simulated object in the simulated playing field includes a simulated ball with a type that depends on the type of sports of the virtual sports game. For example, the simulated ball may be a golf ball, a basketball, a baseball, a football, and/or a soccer ball. The user requested action is also typically an action to control the ball that depends on the type of sports that the virtual game is.

The virtual sports simulator 708 updating a characteristic of the simulated object in the simulated playing field according to the user requested action and can be presented via the device such that the updated characteristic of the simulated object is perceived by the user. The continuous or periodic updating of the simulated object and others provide the perception that a sporting event is occurring live. In any given virtual sports game, the simulated object (e.g., simulated ball) can be acted upon by multiple real participants. In addition, the virtual sports simulator 708 may provide additional simulated objects in the virtual sports game including but not limited to, a referee, a clock, virtual audiences, cheerleaders, living objects, animals, etc.

In one embodiment, the virtual sports simulator 708 provides a simulated participant in the simulated playing field. The simulated participant is typically programmed to act as a teammate or opponent of the real participant. In addition, the simulated participant performs actions on the simulated object. The actions also generally correspond to the type of game of the virtual sports game. One embodiment of the virtual sports simulator 708 includes a participant simulator.

The virtual sports game simulated by the virtual sports simulator 708 may also be a non-competitive sports game, such as, a hike, a scuba diving session, a snorkeling session, a surfing session, etc.

One embodiment of the host server 524 includes a virtual game simulator 710. The virtual game simulator 710 can be any combination of software agents and/or hardware modules able to simulate a virtual game that is played by a real participant in a real world environment. The virtual game simulator 710 may include the gaming environment generator and the object interaction manager module. The virtual game simulator 710 is coupled to the simulator module 704 and the environment simulator module 706. Thus, the virtual game simulator 310 can communicate with the modules to retrieve the simulated objects and/or a gaming environment to be provided to a user. In addition the virtual game simulator 710 can generate the gaming environment to a real user via a device. In general, the gaming environment to correspond to a physical location in the real world environment where the real user is located. For example, the gaming environment can have characteristics that correspond to physical characteristics of the physical location.

In one embodiment, the gaming environment includes a set of simulated objects; the accessibility of which using a device can depend on timing, location, and/or user specific parameters. For example, accessibility of the simulated object via the device depends on a location of the device; accessibility can further depend on the time when the device is located at the location. The simulated objects can include by way of example but not limitation, reward items, ammunition, barriers, goblins, places, events, and other characters.

When a simulated object in the gaming environment is accessible to a real user via a device, the real user can control the simulated object in the gaming environment. In one embodiment, the virtual game simulator 710 detects the movement of the real user and updates a characteristic of the simulated object in the gaming environment at least partially based on the movement of the real user.

In one embodiment, the user requested action on the simulated object in the gaming environment can be identified by the virtual game simulator 710 detecting user interactions with the device. The virtual game simulator 710 can thus update the characteristic of the simulated object in the gaming environment according to the user requested action. The updates are typically presented through the device to be perceived by the user and/or additional other users participating in the virtual game.

In addition, the gaming environment can include additional simulated objects controlled by different real users. For example, another simulated object may be controlled by another real user and interacts with other simulated objects controlled by other real users in the gaming environment. Furthermore, the virtual game simulator 710 can detect the movement of another real user and updates the second simulated object in the gaming environment at least partially based on the movement of the second real user. In one embodiment, the gaming environment includes an arcade game or a strategy game. For example, the arcade game can be a Pacman game and the real user and the second real user control simulated objects representing Pacman. The gaming environment can also include other types of arcade games including but not limited to Centipede, Frogger, etc. The strategy games can include Chess, Checkers, and/or Othello, etc.

One embodiment of the host server 524 includes a virtual performance simulator 712. The virtual performance simulator 712 can be any combination of software agents and/or hardware modules able to simulate a virtual performance in a real world environment.

The virtual performance simulator 712 is coupled to the simulator module 704 and the environment simulator module 706. Thus, the virtual performance simulator 712 can communicate with the modules to retrieve the simulated objects and/or a virtual performance to be provided to a user.

In one embodiment, the virtual performance simulator 712 generates a simulated object that is controlled by a real performer for display on a device located in a physical location in the real world environment. The real performer may be giving a live performance in the real world environment and may not necessarily be located in the physical location where the simulated object is displayed on the device.

The virtual performance simulator 712 can update the simulated object in real time or neat real time according to the live performance given by the real performer in the real world environment. The updates to the simulated object can be presented on the device in the physical location, after a delayed period of time or in real time/near real time.

One embodiment of the host server 524 includes a search engine 722. The search engine 722 can be any combination of software agents and/or hardware modules able to search, detect, and/or identify simulated objects.

The search engine 722 can search or detect objects either automatically or in response to user request. For example, the user can request access to simulated objects and perform a search request. The search request parameters can include, one or more of, the user's location, the current time or a time period. The search that is performed can automatically detect all simulated objects that are available for access to the user. In one embodiment, the simulated objects are further filtered based on the permissions granted to the user and/or the access permissions associated with the simulated object.

The host server 524 represents any one or a portion of the functions described for the modules. More or less functions can be included, in whole or in part, without deviating from the novel art of the disclosure.

FIG. 7B depicts a hardware block diagram of an example host server 524 that generates and controls access to simulated objects. In one embodiment, host server 524 includes a network interface 702, a processing unit 734, a memory unit 736, a storage unit 738, a location sensor 740, and/or a timing module 742. Additional or less units or modules may be included. The host server 524 can be any combination of hardware components and/or software agents for creating, manipulating, controlling, generating simulated objects and environments. The network interface 702 has been described in the example of FIG. 7A.

One embodiment of the host server 524 further includes a processing unit 734. The data received from the network interface 702, location sensor 740, and/or the timing module 742 can be input to a processing unit 734. The location sensor 740 can include GPS receivers, RF transceiver, an optical rangefinder, etc. The timing module 742 can include an internal clock, a connection to a time server (via NTP), an atomic clock, a GPS master clock, etc.

The processing unit 734 can include one or more processors, CPUs, microcontrollers, FPGAs, ASICs, DSPs, or any combination of the above. Data that is input to the host server 734 can be processed by the processing unit 734 and output to a display and/or output via a wired or wireless connection to an external device, such as a mobile phone, a portable device, a host or server computer by way of a communications component. One embodiment of the host server 734 further includes a memory unit 736 and a storage unit 738. The memory unit 735 and a storage unit 738 are, in some embodiments, coupled to the processing unit 734. The memory unit can include volatile and/or non-volatile memory. In generating and controlling access to the simulated objects, the processing unit 734 may perform one or more processes related to generating simulated objects and/or controlling access to simulated objects.

In some embodiments, any portion of or all of the functions described of the various example modules in the host server 524 of the example of FIG. 7A can be performed by the processing unit 734. In particular, with reference to the host server illustrated in FIG. 7A, the object simulator, environment simulator, access permissions functions, interactions manager functions, environmental sensing functions, object control functions, virtual sports simulator, virtual game simulator, and/or virtual performance simulator can be performed via any of the combinations of modules in the control subsystem that are not illustrated, including, but not limited to, the processing unit 734 and/or the memory unit 336.

### Background Information on Computer Systems

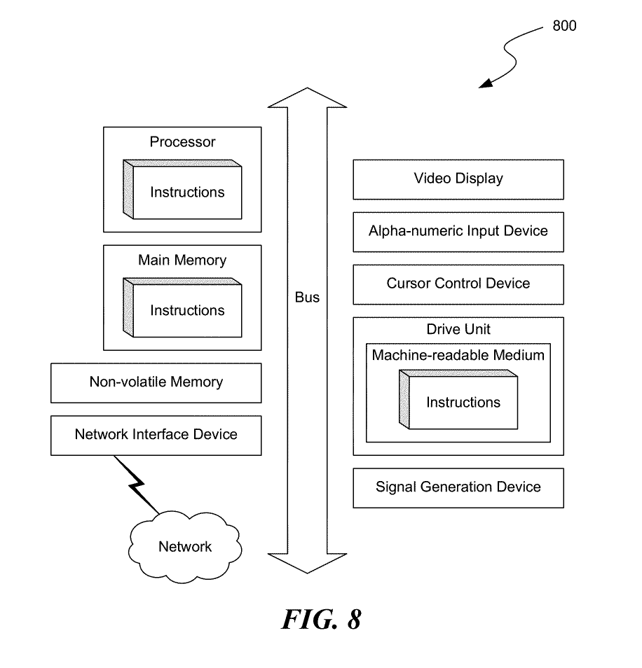

FIG. 8 depicts a diagrammatic representation 800 of a machine in the example form of a computer system within which a set of instructions, for causing the machine to perform any one or more of the methodologies discussed in this specification, can be executed.

In alternative embodiments, the machine operates as a standalone device or can be connected (e.g., networked) to other machines. In a networked deployment, the machine can operate in the capacity of a server or a client machine in a client-server network environment, or as a peer machine in a peer-to-peer (or distributed) network environment.

The machine can be a server computer, a client computer, a personal computer (PC), a server computer, a user device, a tablet, a phablet, a laptop computer, a set-top box (STB), a personal digital assistant (PDA), a thin-client device, a smartphone device, a console, a hand-held console, a (hand-held) gaming device, a music player, any portable, mobile, hand-held device, or any other machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed repository, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 2800 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall can additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

### Recitals and Disclaimers

The description and drawings are illustrative and are not to be construed as limiting. Accordingly, the invention is not limited except as by the appended claims. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” “an embodiment” or “some embodiments” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are provided in this specification. Any titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112(f), other aspects may likewise be embodied as a means-plus-function claim, or in other forms, such as being embodied in a computer-readable medium. (Any claims intended to be treated under 35 U.S.C. §112(f) will begin with the words “means for”.) Accordingly, the applicant reserves the right to add additional claims after filing the application to pursue such additional claim forms for other aspects of the disclosure.

What is claimed is:

1. A head-mounted device for providing multiple modes of user interaction, the head-mounted device comprising:
a display device configured to present visual information to the user; and
a user input device configured to receive an input from the user selecting one of a plurality of interaction modes, including at least a reality mode, an augmented reality mode, and a virtual reality mode;
wherein when in reality mode, the visual information includes a live video feed from an image capture device associated with the head-mounted display device, the image capture device configured to capture images of a physical environment;
wherein when in augmented reality mode, the visual information includes live video feed from the image capture device along with computer-generated simulated objects or computer image processing; and
wherein when in virtual reality mode, the visual information includes a computer-generated simulated environment.

2. The head-mounted device of claim 1, wherein the image capture device includes two forward facing cameras attached to the head-mounted device and the display device includes two display screens, and wherein the forward facing cameras and the two display screens are configured to provide the user with a stereoscopic view of the surrounding physical environment.

3. The head-mounted device of claim 2, wherein the image capture device further includes additional cameras configured to provide additional simultaneous viewing angles or a larger field of view.

4. The head-mounted device of claim 1, wherein the image capture device is remotely located from the head-mounted display device and in communication with the head-mounted display device via a wireless network connection.

5. The head-mounted device of claim 1, wherein the display device incorporates optical projection technology to project the visual information onto the retina of the user.

6. The head-mounted device of claim 1, wherein when in augmented reality mode, the live video feed from the image capture device is processed and adjusted to compensate for a visual impairment of the user.

7. The head-mounted device of claim 1, further comprising:
an audio output device configured to present audio information to the user;
wherein the audio information includes one or more of, an audio feed from a first audio input device or microphone or set of microphones configured to capture audio from the physical environment surrounding the head-mounted device, an audio feed from a second audio input device configured to capture audio at a remote location, a pre-recorded audio, or a computer-generated audio.

8. The head-mounted device of claim 1, further comprising:
a location sensor configured to gather location data including a current location of the head-mounted device in the physical environment;
a timer module configured to gather a time data including an absolute or relative time based on the current location of the head-mounted device; and
an object identifier module configured to detect and retrieve one or more simulated objects, based on the location data and/or the time data, the simulated objects for presentation via the display device when the head-mounted device is in augmented reality mode or virtual reality mode.

9. The head mounted device of claim 6, further comprising:
a network interface configured to receive simulated objects from one or more host servers, the simulated objects stored in a remote repository.

10. A system for providing multiple modes of user interaction via a head-mounted device, the system comprising:
a sensor unit configured to capture sensor data from the physical environment surrounding the head-mounted device;
a sensory output unit configured to present sensory output information to a user of the head-mounted device;
a user input unit configured to receive a user input;
a processor unit; and
a memory unit having instructions stored thereon, which when executed by the processor unit, cause the system to:
receive, via the user input unit, a user selection of a first, second, or third user interaction mode; and
if the user selection is the first user interaction mode:
capture a live sensor data feed via the sensor unit; and
present sensory information including the live sensor data feed via the sensory output unit;
if the user selection is the second user interaction mode:
capture a live sensor data feed via the sensor unit;
generate one or more simulated objects, the one or more simulated objects including user perceptible characteristics;
present sensory output information including the live sensor data feed and the one or more simulated objects via the sensory output unit; and
if the user selection is the third user interaction mode:
generate a simulated environment, the simulated environment including user perceptible characteristics; and
present sensory output information including the simulated environment via the sensory output unit.

11. The system of claim 10, wherein the first user interaction mode is a reality mode, the second user interaction mode is an augmented reality mode, and the third user interaction mode is a virtual reality mode.

12. The system of claim 10,
wherein the sensor unit includes one or more image capture devices;
wherein the sensor data includes video captured by the one or more image capture devices;
wherein the sensory output unit includes one or more displays;
wherein the sensory output information includes visual information configured for presentation via the one or more displays; and
wherein the one or more simulated objects include visual characteristics.

13. The system of claim 10,
wherein the sensor unit includes one or more audio capture devices;
wherein the sensor data includes audio captured by the one or more audio capture devices;
wherein the sensory output unit includes one or more speakers;
wherein the sensory output information includes audible information configured for presentation via the one or more speakers; and
wherein the one or more simulated objects include audible characteristics.

14. The system of claim 12, wherein the image capture unit includes two forward facing cameras and the display unit includes two display screens, and wherein the forward facing cameras and the two display screens are configured to provide the user with a stereoscopic view of the surrounding physical environment.

15. The system of claim 14, wherein the image capture unit further includes additional cameras configured to provide additional simultaneous viewing angles or a larger field of view.

16. The system of claim 12, wherein the display unit incorporates optical projection technology to project the visual information onto the retina of the user.

17. The system of claim 12, wherein the memory unit has further instructions stored thereon, which when executed by the processor unit, cause the system to further:
detect a vision impairment of the user; and
adjust presentation via the display unit to correct for the vision impairment.

18. The system of claim 10, further comprising:
a location sensor; and
an object identifier module;
wherein the memory unit has further instructions stored thereon, which when executed by the processor unit, cause the system to further:
gather, via the location sensor, a location data including a current location of the head-mounted device in the physical environment; and
detect and retrieve, via the object identifier module, one or more simulated objects based on the gathered location data.

19. The system of claim 10, further comprising:
a timer module; and
an object identifier module;
wherein the memory unit has further instructions stored thereon, which when executed by the processor unit, cause the system to further:
gather, via the timer module, a time data including an absolute or relative time based on the current location of the head-mounted device; and
detect and retrieve, via the object identifier module, one or more simulated objects based on the gathered time data.

20. The system of claim 10, further comprising:
a network interface;
wherein the memory unit has further instructions stored thereon, which when executed by the processor unit, cause the system to further:
receive simulated objects from one or more host servers, the simulated objects stored in a remote repository.

21. A method for providing multiple modes of user interaction via a head-mounted device, the head-mounted device associated with a sensor unit configured to capture sensor data from the physical environment surrounding the head-mounted device, a sensory output unit configured to present sensory output information to a user of the head-mounted device, and a user input unit configured to receive a user input, the method comprising:
receiving, via the user input unit, a user selection of a first, second, or third user interaction mode; and
if the user selection is the first user interaction mode:
capturing a live sensor data feed via the sensor unit; and
presenting sensory output information including the live sensor data feed via the sensory output unit;
if the user selection is the second user interaction mode:
capturing a live sensor data feed via the sensor unit;
generating one or more simulated objects, the one or more simulated objects including user perceptible characteristics;
presenting sensory output information including the live sensor data feed with the one or more simulated objects via the sensory output unit; and
if the user selection is the third user interaction mode:
generating a simulated environment, the simulated environment including user perceptible characteristics; and
presenting sensory output information including the simulated environment via the sensory output unit.

22. The method of claim 21, wherein the first user interaction mode is a reality mode, the second user interaction mode is an augmented reality mode, and the third user interaction mode is a virtual reality mode.

23. The method of claim 21,
wherein the sensor unit includes one or more image capture devices;
wherein the sensor data includes video captured by the one or more image capture devices;
wherein the sensory output unit includes one or more displays;
wherein the sensory output information includes visual information configured for presentation via the one or more displays; and
wherein the one or more simulated objects include visual characteristics.

24. The system of claim 21,
wherein the sensor unit includes one or more audio capture devices;
wherein the sensor data includes audio captured by the one or more audio capture devices;
wherein the sensory output unit includes one or more speakers;
wherein the sensory output information includes audible information configured for presentation via the one or more speakers; and
wherein the one or more simulated objects include audible characteristics.

25. The method of claim 23, further comprising:
detecting a vision impairment of the user; and
adjusting presentation via the display unit to correct for the vision impairment.

26. The method of claim 21, wherein the head-mounted device is further associated with a location sensor and an object identifier module, the method further comprising:
gathering, via the location sensor, a location data including a current location of the head-mounted device in the physical environment; and
detecting and retrieving, via the object identifier module, one or more simulated objects based on the gathered location data.

27. The method of claim 21, wherein the head-mounted device is further associated with a timer module and an object identifier module, the method further comprising:
gathering, via the timer module, a time data including an absolute or relative time; and
detecting and retrieving, via the object identifier module, one or more simulated objects based on the gathered time data.

28. The method of claim 21, wherein the head-mounted device is further associated with a network interface, the method further comprising:
receiving, via the network interface, simulated objects from one or more host servers, the simulated objects stored in a remote repository.
